(19) United States
(12) Patent Application Publication
(10) Pub. No.: US 2019/0218083 A1
(43) Pub. Date: Jul. 18, 2019

(54) FORKLIFT

(71) Applicant: DOOSAN CORPORATION, Seoul (KR)

(72) Inventors: Deok Rae KIM, Incheon (KR); Yong Seok RYU, Incheon (KR); Byung Kwon LEE, Incheon (US); Jun Il YI, Seoul (KR)

(73) Assignee: DOOSAN CORPORATION, Seoul (KR)

(21) Appl. No.: 16/327,470

(22) PCT Filed: Aug. 24, 2017
(86) PCT No.: PCT/KR2017/009253

§ 371 Date: Mar. 26, 2019

(30) Foreign Application Priority Data
Aug. 24, 2016 (KR) 10-2016-0107916

(51) Int. Cl. B66F 9/22; B66F 17/00; B66F 9/12; B66F 9/075

(52) U.S. Cl. CPC B66F 9/22; B66F 9/07572; B66F 9/12; B66F 17/003

(57) ABSTRACT

A forklift according to an exemplary embodiment of the present disclosure includes: a first hydraulic pump and a second hydraulic pump each of which generates a working fluid; a lift cylinder which raises or lowers a carriage; a first hydraulic line which supplies the working fluid from the first hydraulic pump to the lift cylinder and a second hydraulic line which supplies the working fluid from the second hydraulic pump to the lift cylinder; a first lift spool which controls the working fluid to be supplied to the lift cylinder through the first hydraulic line and a second lift spool which controls the working fluid to be supplied to the lift cylinder through the second hydraulic line; a first pilot line which transmits a pilot signal for operating the first lift spool and a second pilot line which transmits a pilot signal for operating the second lift spool; and an opening/closing valve which selectively closes any one of the first pilot line and the second pilot line.

### TECHNICAL FIELD

The present disclosure relates to a forklift, and more particularly, to a forklift which improves stability of an engine.

### BACKGROUND ART

In general, a forklift is used to raise or lower a heavy object or to transport the object to a desired position. The forklift includes a vehicle body which is supported by a front driving wheel and a rear steering wheel, and a mast assembly which is installed at a front side of the vehicle body.

The mast assembly includes a mast, and a carriage provided to be vertically movable along the mast, and the carriage is raised or lowered by a lift cylinder vertically installed along the mast. A pair of forks or various types of attachments, for example, a hinged bucket, a side shift, a rod stabilizer, a rotating fork, and the like are mounted on the carriage.

In addition, the mast assembly may be formed to be inclined forward or rearward by a tilt cylinder.

Further, the forklift further includes a hydraulic system for operating the lift cylinder, the tilt cylinder, and the various types of attachments.

The hydraulic system includes a first hydraulic pump and a second hydraulic pump. Further, the first hydraulic pump and the second hydraulic pump are tandem pumps which are installed in series with respect to each other, and the first hydraulic pump and the second hydraulic pump are operated by a power source such as an internal combustion engine or an electric motor to supply a working fluid stored in an oil tank to a necessary site.

An operation of raising or lowering the carriage loaded with a heavy object along the mast is an operation, among various operations performed by the forklift, which requires a relatively highest load. Therefore, the first hydraulic pump and the second hydraulic pump are often maximally operated to raise or lower the carriage along the mast.

By the way, an increase in pressure of the hydraulic pump means an increase in driving torque, and a sum of driving torque for a period of time when the pressure is increased means an increase in impulse caused by a hydraulic pressure. Further, since the impulse has the same dimension as momentum of an engine, a rotational speed of the engine is determined depending on a difference in momentum.

In addition, torque of the engine is generated by exploding fuel injected by injectors, and unlike the load of the hydraulic pump, the torque is generated discontinuously based on a fuel injection interval between the injectors. That is, a sum of torque of the engine for a predetermined period of time means angular momentum of the engine.

As described above, the rotational speed of the engine is determined depending on a difference between the impulse and the angular momentum. That is, a difference in angular acceleration occurs to the extent of a difference between the load and the torque of the engine at each moment, and an increase or decrease in rotational speed is made based on whether the angular acceleration has a positive or negative value.

Therefore, at a point in time at which the hydraulic pressure is released, the increase in pressure of the working fluid means the increase in impulse, and the increase in pressure continues for a very short period of time, but for this period of time, the rotational speed of the engine is decreased to the extent of the difference between the load and the torque.

Further, the decrease in rotational speed of the engine continues until torque is added by subsequent fuel injection of the injector.

However, there is a problem in that when the rotational speed is decreased to a predetermined level (stall point) or lower before the fuel injection is performed, the rotational speed is not increased any further and a stall occurs.

### DISCLOSURE

### Technical Problem

An exemplary embodiment of the present disclosure provides a forklift which improves stability of an engine by controlling a pressure of a working fluid.

### Technical Solution

An exemplary embodiment of the present disclosure provides a forklift which includes a mast and a carriage which is raised or lowered along the mast, the forklift including: a first hydraulic pump and a second hydraulic pump each of which generates a working fluid; a lift cylinder which raises or lowers the carriage; a first hydraulic line which supplies the working fluid from the first hydraulic pump to the lift cylinder and a second hydraulic line which supplies the working fluid from the second hydraulic pump to the lift cylinder; a first lift spool which controls the working fluid to be supplied to the lift cylinder through the first hydraulic line and a second lift spool which controls the working fluid to be supplied to the lift cylinder through the second hydraulic line; a first pilot line which transmits a pilot signal for operating the first lift spool and a second pilot line which transmits a pilot signal for operating the second lift spool; and an opening/closing valve which selectively closes any one of the first pilot line and the second pilot line.

The opening/closing valve may close any one of the first pilot line and the second pilot line when the carriage is raised to a predetermined height or higher, and the opening/closing valve may open the first pilot line and the second pilot line when the carriage is lowered to a height below the predetermined height.

The forklift may further include a change-over switch which is installed at the predetermined height of the mast, generates an OFF signal when the carriage reaches the predetermined height, and generates an ON signal when the carriage moves below the predetermined height. Further, the opening/closing valve may operate based on a signal of the change-over switch.

The forklift may further include an operating unit which includes a lift operating lever. The operating unit may generate a pilot signal to be transmitted to the first lift spool and the second lift spool.

The lift cylinder may include a first lift cylinder which is connected to the first hydraulic line, and a second lift cylinder which is connected to the second hydraulic line.

The forklift may further include: a first relief valve which is installed on the first hydraulic line and drains the working fluid in the first hydraulic line when a pressure in the first hydraulic line becomes a predetermined pressure or higher; and a second relief valve which is installed on the second hydraulic line and drains the working fluid in the second hydraulic line when a pressure in the second hydraulic line becomes a predetermined pressure or higher.

### Advantageous Effects

According to the exemplary embodiment of the present disclosure, the forklift may improve stability of the engine by controlling the pressure of the working fluid.

### DESCRIPTION OF DRAWINGS

FIG. 1 is a perspective view illustrating a part of a front side of a forklift according to an exemplary embodiment of the present disclosure.

FIG. 2 is a hydraulic circuit diagram for operating a lift cylinder used for the forklift in FIG. 1.

FIGS. 3 and 4 are hydraulic circuit diagrams illustrating operating states of the lift cylinder which are distinguished from each other.

FIGS. 5 and 6 are side views of the forklift which illustrate operations of a change-over switch in accordance with raising or lowering of a carriage.

FIGS. 7 and 8 are graphs illustrating operational effects of a comparative example and an experimental example according to the exemplary embodiment of the present disclosure.

### BEST MODE

Hereinafter, exemplary embodiments of the present disclosure will be described in detail with reference to the accompanying drawings so that those with ordinary skill in the art to which the present disclosure pertains may easily carry out the exemplary embodiments. The present disclosure may be implemented in various different ways, and is not limited to the exemplary embodiments described herein.

It is noted that the drawings are schematic, and are not illustrated based on actual scales. Relative dimensions and proportions of parts illustrated in the drawings are exaggerated or reduced in size for the purpose of clarity and convenience in the drawings, and any dimension is just illustrative but not restrictive. The same reference numerals designate the same structures, elements or components illustrated in two or more drawings in order to exhibit similar characteristics.

Exemplary embodiments of the present disclosure illustrate ideal exemplary embodiments of the present disclosure in detail. As a result, various modifications of the drawings are expected. Therefore, the exemplary embodiments are not limited to specific forms in regions illustrated in the drawings, and for example, include modifications of forms by the manufacture thereof.

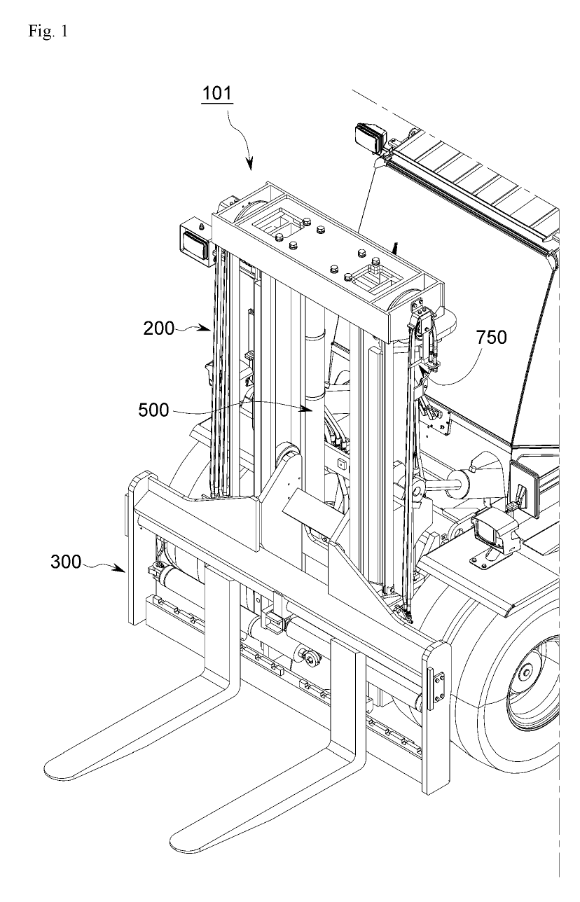

Hereinafter, a forklift 101 according to an exemplary embodiment of the present disclosure will be described with reference to FIGS. 1 to 6.

As illustrated in FIG. 1, the forklift 101 according to the exemplary embodiment of the present disclosure includes a mast 200, and a carriage 300 which is raised or lowered along the mast 200.

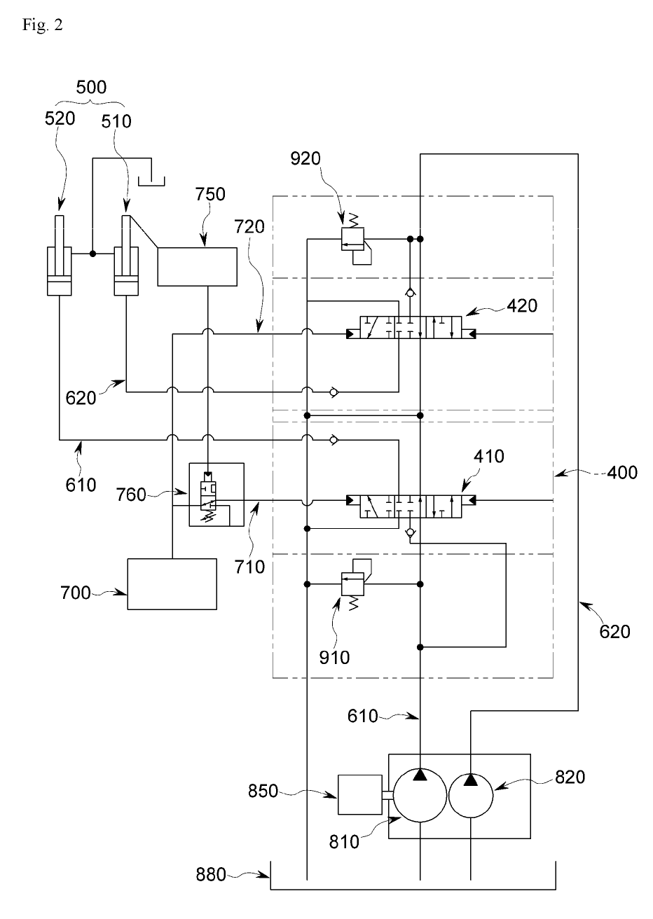

In addition, as illustrated in FIG. 2, the forklift 101 according to the exemplary embodiment of the present disclosure includes a first hydraulic pump 810, a second hydraulic pump 820, a lift cylinder 500, a first hydraulic line 610, a second hydraulic line 620, a first lift spool 410, a second lift spool 420, a first pilot line 710, a second pilot line 720, and an opening/closing valve 760.

In addition, the forklift 101 according to the exemplary embodiment of the present disclosure may further include a change-over switch 750, an operating unit 700, a first relief valve 910, and a second relief valve 920.

In addition, the forklift 101 according to the exemplary embodiment of the present disclosure may further include an engine 850 and an oil tank 880.

Each of the first hydraulic pump 810 and the second hydraulic pump 820 generates a working fluid. As an example, the first hydraulic pump 810 and the second hydraulic pump 820 may be tandem pumps which are installed in series with respect to each other, and the first hydraulic pump 810 and the second hydraulic pump 820 are operated by the engine 850 and pump the working fluid stored in the oil tank 880.

In addition, in the exemplary embodiment of the present disclosure, the engine 850 generates torque by exploding fuel injected by injectors and discontinuously generates torque at a fuel injection interval between the injectors. That is, in the exemplary embodiment of the present disclosure, a sum of torque of the engine 850 for a predetermined period of time means angular momentum of the engine 850.

The lift cylinder 500 raises or lowers the carriage 300 by being supplied with the working fluid from the first hydraulic pump 810 and the second hydraulic pump 820.

In the exemplary embodiment of the present disclosure, the lift cylinder 500 may include a first lift cylinder 510 which is supplied with the working fluid from the first hydraulic pump 810, and a second lift cylinder 520 which is supplied with the working fluid from the second hydraulic pump 820.

The first hydraulic line 610 delivers the working fluid from the first hydraulic pump 810 to the first lift cylinder 510. Further, the second hydraulic line 620 delivers the working fluid from the second hydraulic pump 810 to the second lift cylinder 520.

That is, when the working fluid generated by the first hydraulic pump 810 and the second hydraulic pump 820 is supplied to the first lift cylinder 510 and the second lift cylinder 520 through the first hydraulic line 610 and the second hydraulic line 620, the carriage 300 is raised as the first lift cylinder 510 and the second lift cylinder 520 push the carriage 300 upward.

The first lift spool 410 controls the working fluid supplied to the first lift cylinder 510 through the first hydraulic line 610. Further, the second lift spool 420 controls the working fluid supplied to the second lift cylinder 520 through the second hydraulic line 620.

In addition, in the exemplary embodiment of the present disclosure, a main control valve 400 has multiple spools including the first lift spool 410 and the second lift spool 420.

The first pilot line 710 transmits a pilot signal for operating the first lift spool 410, and the second pilot line 720 transmits a pilot signal for operating the second lift spool 420. Here, the pilot signal may be transmitted as an electrical signal or a pressure of the working fluid for the pilot signal.

The operating unit 700 is connected to the first pilot line 710 and the second pilot line 720 and generates the pilot signal to be transmitted to the first lift spool 410 and the second lift spool 420. As an example, the operating unit 700 may include a lift operating lever.

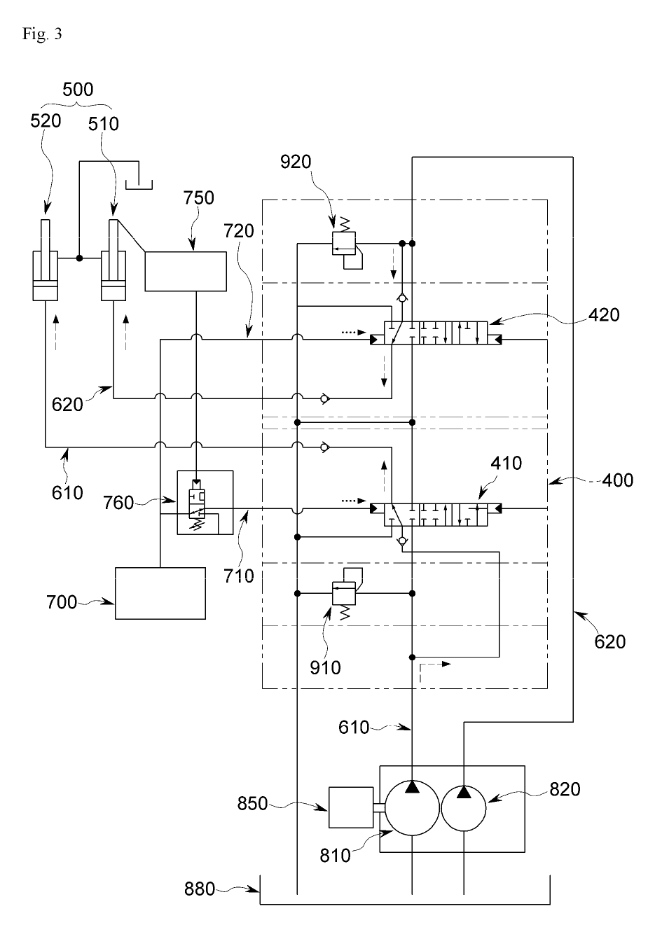

As illustrated in FIG. 3, when the pilot signal generated by the operating unit 700 is transmitted to the first lift spool 410 and the second lift spool 420 through the first pilot line 710 and the second pilot line 720, the first lift spool 410 and the second lift spool 420 perform a change-over operation. That is, as a position of the first lift spool 410 and a position of the second lift spool 420 are shifted, the working fluid from the first hydraulic pump 810 and the second hydraulic pump 820 is supplied to the first lift cylinder 510 and the second lift cylinder 520 through the first hydraulic line 610 and the second hydraulic line 620, respectively. Further, the first lift cylinder 510 and the second lift cylinder 520 raise the carriage 300 by using the pressure of the working fluid.

In the exemplary embodiment of the present disclosure, the opening/closing valve 760 selectively closes any one of the first pilot line 710 and the second pilot line 720. As an example, in FIGS. 2 to 4, the opening/closing valve 760 opens or closes the first pilot line 710, but the exemplary embodiment of the present disclosure is not limited thereto. That is, the opening/closing valve 760 may open or close the second pilot line 720.

In addition, in the exemplary embodiment of the present disclosure, the opening/closing valve 760 closes any one of the first pilot line 710 and the second pilot line 720 when the carriage 300 is raised to a predetermined height or higher, and the opening/closing valve 760 opens both of the first pilot line 710 and the second pilot line 720 when the carriage 300 is lowered to a height below a predetermined height.

The change-over switch 750 is installed at a predetermined height of the mast 200 and generates an OFF signal when the carriage 300 reaches the predetermined height, and the change-over switch 750 generates an ON signal when the carriage 300 moves below the predetermined height.

The change-over switch 750 may be configured by various publicly-known methods in the corresponding technical field. As an example, the change-over switch 750 may be a lever switch installed at the predetermined height of the mast 200, and the lever switch may be structured to operate as the carriage 300 is raised.

In addition, the opening/closing valve 760 may operate based on the signal from the change-over switch 750 to close any one of the first pilot line 710 and the second pilot line 720 or open both of the first pilot line 710 and the second pilot line 720.

In addition, in the exemplary embodiment of the present disclosure, the operation of the opening/closing valve 760 is not necessarily controlled by the change-over switch 750, and the opening/closing valve 760 may be manually manipulated by an operator or may be operated by receiving a signal from other publicly-known sensing means. In this case, the change-over switch 750 may be omitted.

The first relief valve 910 is installed on the first hydraulic line 610 and drains the working fluid in the first hydraulic line 610 when the pressure in the first hydraulic line 610 becomes a predetermined pressure or higher.

The second relief valve 920 is installed on the second hydraulic line 620 and drains the working fluid in the second hydraulic line 620 when the pressure in the second hydraulic line 620 becomes a predetermined pressure or higher.

The predetermined pressure may be variously set in consideration of stability of the entire hydraulic system.

When the first lift cylinder 510 and the second lift cylinder 520 lower the carriage 300 after raising the carriage 300 by being supplied with the working fluid, a high pressure is temporarily applied to the first hydraulic line 610 and the second hydraulic line 620. In this case, the pressure in the first hydraulic line 610 and the pressure in the second hydraulic line 620 are adjusted by the first relief valve 910 and the second relief valve 920.

However, in a case in which the carriage 300 is raised to approach the highest position, the pressure of the working fluid in the first hydraulic line 610 and the second hydraulic line 620 may be very greatly increased at a point in time at which the carriage 300 is lowered and the working fluid is released through the first relief valve 910 and the second relief valve 920, and the increase in pressure of the working fluid has a negative effect on stability of the engine 850.

Specifically, since the increase in pressure of the working fluid means an increase in impulse, the rotational speed of the engine 850 is decreased due to the increase in impulse, and in some instances, the rotational speed of the engine 850 is decreased to a predetermined level (stall point) or lower, and as a result, the rotational speed cannot be recovered, and a stall may occur.

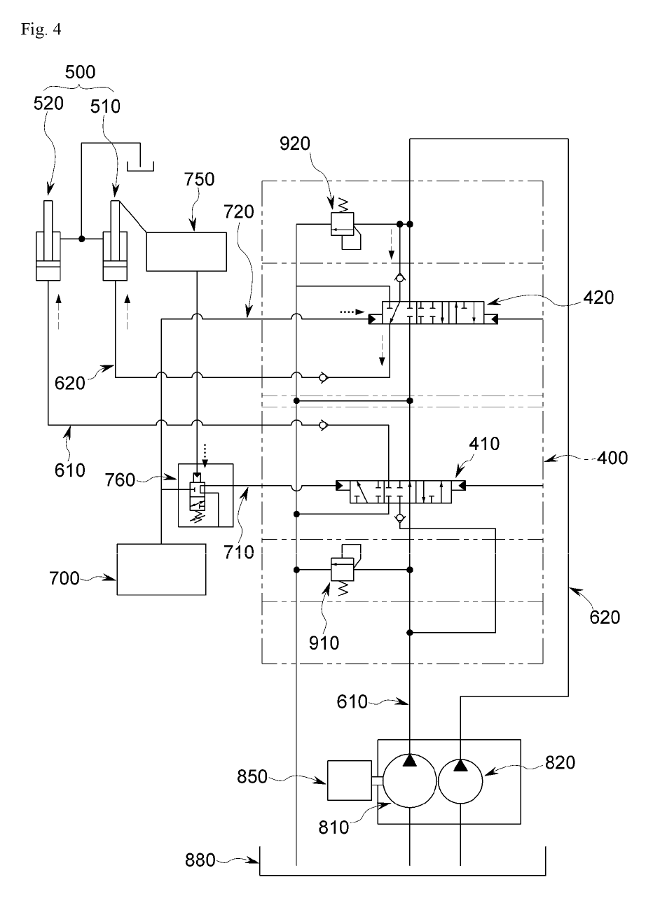

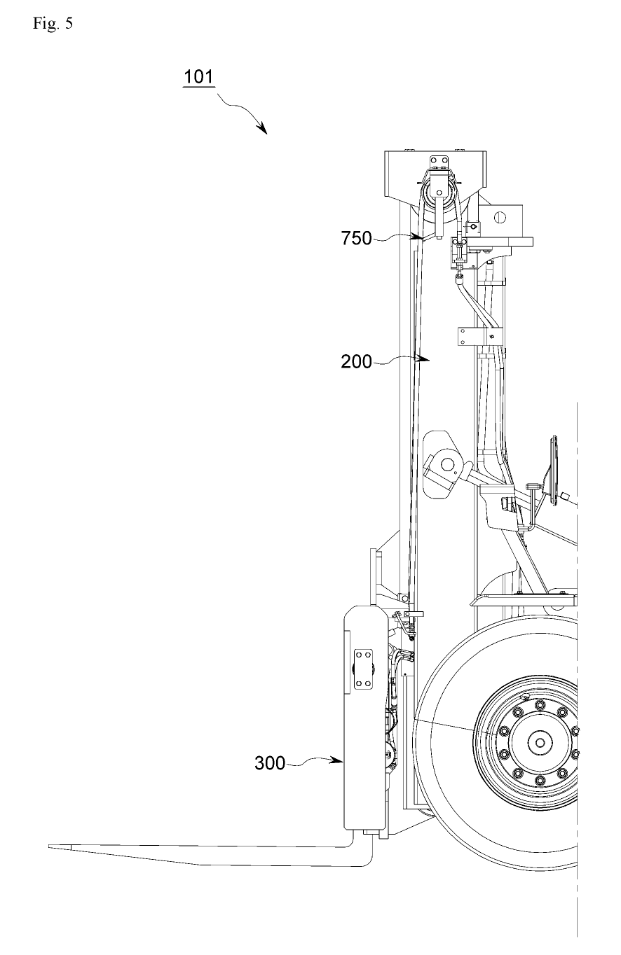

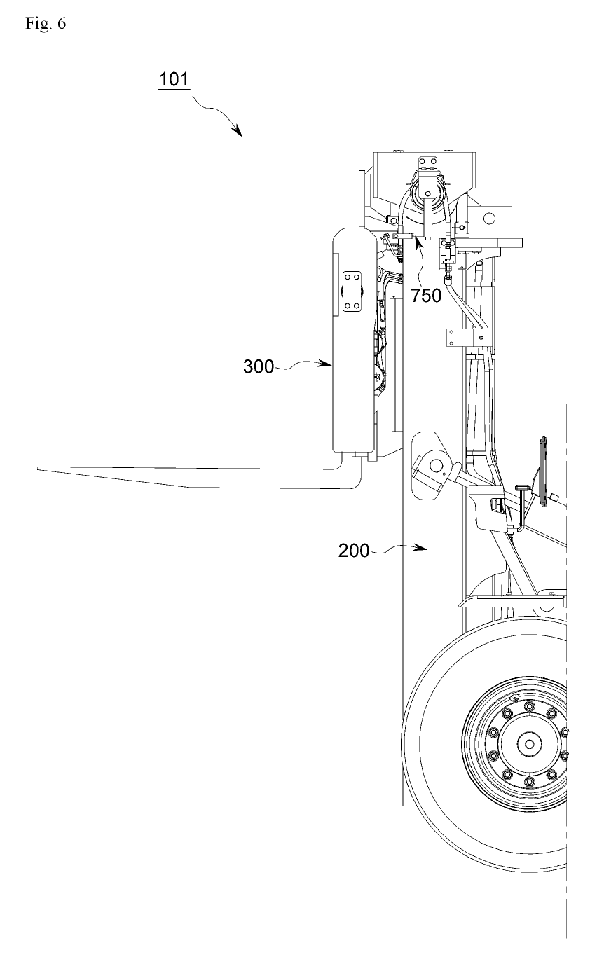

However, in the exemplary embodiment of the present disclosure, when the carriage 300 is raised to a predetermined height or higher, the change-over switch 750 operates, and the opening/closing valve 760 closes any one of the first pilot line 710 and the second pilot line 720, as illustrated in FIG. 4. FIGS. 5 and 6 illustrate a state in which the change-over switch 750 operates as the carriage 300 is raised.

Therefore, an overall flow rate of the working fluid to be supplied to the lift cylinder 500 is decreased. This means that a flow rate of the working fluid drained from the lift cylinder 500 is decreased. That is, it is possible to minimize an increase in impulse. Therefore, it is possible to inhibit the rotational speed of the engine 850 from being excessively decreased due to the increase in impulse, and it is possible to prevent a stall of the engine 850.

Meanwhile, in the exemplary embodiment of the present disclosure, the impulse may be further decreased as the predetermined height at which the change-over switch 750 operates is decreased, and thus it is possible to further ensure stability of the engine 850. However, if the predetermined height is too low, the working fluid is supplied too early to the lift cylinder 500 only by the single hydraulic pump 820, and as a result, a speed of lifting the carriage 300 is decreased. Therefore, the predetermined height may be appropriately set in consideration of workability of the forklift 101.

With the above-mentioned configuration, the forklift 101 according to the exemplary embodiment of the present disclosure may improve stability of the engine 850 by controlling the pressure of the working fluid.

Specifically, the first hydraulic pump 810 and the second hydraulic pump 820 actively control a flow rate of the working fluid to be supplied to the lift cylinder 500 to minimize an increase in pressure of the working fluid that occurs when the carriage 300 is raised or lowered, and as a result, it is possible to prevent an excessive decrease in rotational speed of the engine 850 by decreasing the impulse to be applied to the engine 850.

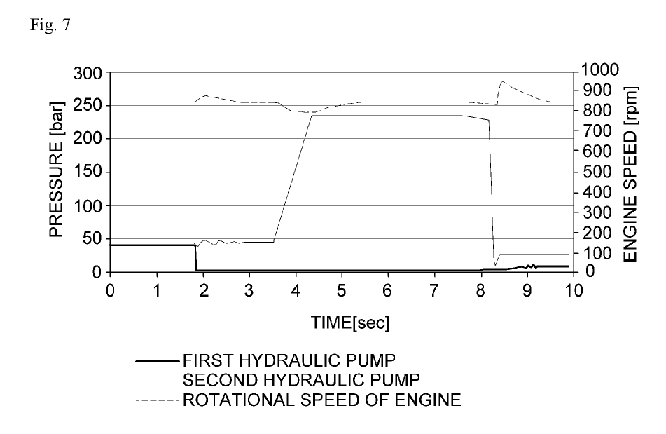

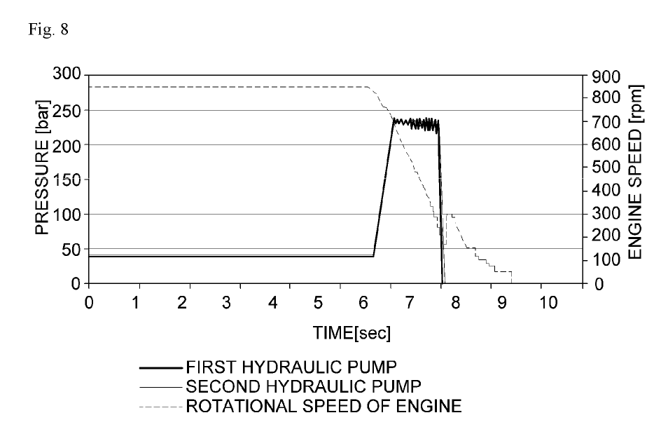

Hereinafter, an operational effect will be described with reference to FIGS. 6 and 7 in consideration of a comparison between a comparative example and an experimental example according to the exemplary embodiment of the present disclosure.

FIG. 6 illustrates a change in rotational speed of the engine 850 in the experimental example in which the opening/closing valve 760 closes the first pilot line 710 and the first hydraulic pump 810 cuts off the supply of the working fluid to the lift cylinder 500 when the carriage 300 is raised to the predetermined height according to the exemplary embodiment of the present disclosure.

FIG. 7 illustrates a change in rotational speed of the engine 850 in the comparative example in which both of the first hydraulic pump 810 and the second hydraulic pump 820 persistently supply the working fluid to the lift cylinder even though the carriage 300 is raised to the predetermined height or higher.

As illustrated in FIG. 6, in the experimental example, it can be seen that when the carriage 300 is raised to the predetermined height and thus the change-over switch 750 operates (S), the pressure of the working fluid supplied by the first hydraulic pump 810 is blocked, and the rotational speed of the engine 850 is not decreased even though the carriage 300 is lowered thereafter.

In contrast, as illustrated in FIG. 7, in the comparative example, it can be seen that both of the first hydraulic pump 810 and the second hydraulic pump 820 supply the working fluid, and impulse occurs due to an excessive increase in pressure, and as a result, a stall occurs as the engine 850 loses the rotational speed.

While the exemplary embodiments of the present disclosure have been described with reference to the accompanying drawings, those skilled in the art will understand that the present disclosure may be carried out in any other specific form without changing the technical spirit or an essential feature thereof.

Accordingly, it should be understood that the aforementioned exemplary embodiments are described for illustration in all aspects and are not limited, and the scope of the present disclosure shall be represented by the claims to be described below, and it should be construed that all of the changes or modified forms induced from the meaning and the scope of the claims, and an equivalent concept thereto are included in the scope of the present disclosure.

### INDUSTRIAL APPLICABILITY

The forklift according to the exemplary embodiment of the present disclosure may be used to improve stability of the engine by controlling the pressure of the working fluid.

1. A forklift which comprises a mast and a carriage which is raised or lowered along the mast, the forklift comprising:
a first hydraulic pump and a second hydraulic pump each of which generates a working fluid;
a lift cylinder which raises or lowers the carriage;
a first hydraulic line which supplies the working fluid from the first hydraulic pump to the lift cylinder and a second hydraulic line which supplies the working fluid from the second hydraulic pump to the lift cylinder;
a first lift spool which controls the working fluid to be supplied to the lift cylinder through the first hydraulic line and a second lift spool which controls the working fluid to be supplied to the lift cylinder through the second hydraulic line;
a first pilot line which transmits a pilot signal for operating the first lift spool and a second pilot line which transmits a pilot signal for operating the second lift spool; and
an opening/closing valve which selectively closes any one of the first pilot line and the second pilot line.

2. The forklift of claim 1, wherein the opening/closing valve closes any one of the first pilot line and the second pilot line when the carriage is raised to a predetermined height or higher, and the opening/closing valve opens the first pilot line and the second pilot line when the carriage is lowered to a height below the predetermined height.

3. The forklift of claim 1, further comprising:
a change-over switch which is installed at the predetermined height of the mast, generates an OFF signal when the carriage reaches the predetermined height, and generates an ON signal when the carriage moves below the predetermined height,
wherein the opening/closing valve operates based on a signal of the change-over switch.

4. The forklift of claim 1, further comprising:
an operating unit which includes a lift operating lever,
wherein the operating unit generates a pilot signal to be transmitted to the first lift spool and the second lift spool.

5. The forklift of claim 1, wherein the lift cylinder includes a first lift cylinder which is connected to the first hydraulic line, and a second lift cylinder which is connected to the second hydraulic line.

6. The forklift of claim 1, further comprising:
a first relief valve which is installed on the first hydraulic line and drains the working fluid in the first hydraulic line when a pressure in the first hydraulic line becomes a predetermined pressure or higher; and
a second relief valve which is installed on the second hydraulic line and drains the working fluid in the second hydraulic line when a pressure in the second hydraulic line becomes a predetermined pressure or higher.
